(19) United States
(12) Patent Application Publication
(10) Pub. No.: US 2024/0199453 A1
(43) Pub. Date: Jun. 20, 2024

(54) WATER TREATMENT DEVICE USING ELECTROSTATIC FIELD

(71) Applicant: U&G TECHNOLOGY CO., LTD., Incheon (KR)

(72) Inventor: Sanguk KIM, Incheon (KR)

(73) Assignee: U&G TECHNOLOGY CO., LTD., Incheon (KR)

(21) Appl. No.: 18/489,556

(22) Filed: Oct. 18, 2023

(30) Foreign Application Priority Data
Dec. 14, 2022 (KR) 10-2022-0174898

(51) Int. Cl. C02F 1/48

(52) U.S. Cl. CPC C02F 1/487; C02F 2201/48

(57) ABSTRACT

Disclosed is a water treatment device using an electrostatic field which configures a water treatment device to generate a large amount of static electricity between a high voltage unit (+) and a low voltage unit (−) by installing the high voltage unit (+) and the low voltage unit (−) to be close to each other while crossing the high voltage unit (+) and a low voltage unit (−) each other, and supplying power to sufficiently obtain low-hardness water in spite of configuring the water treatment device in a small size and installing the water treatment device on a pipe in which water flows.

### CROSS-REFERENCE TO RELATED APPLICATIONS

This application claims the priority of Korean Patent Application No. 2022-174898 filed on Dec. 14, 2022, in the Korean Intellectual Property Office, the disclosure of which is incorporated herein by reference.

### BACKGROUND OF THE INVENTION

### Field of the Invention

The present invention relates to a water treatment device using an electrostatic field, and more particularly, to a water treatment device using an electrostatic field, which configures a water treatment device to generate a large amount of static electricity between a high voltage unit (+) and a low voltage unit (−) by installing the high voltage unit (+) and the low voltage unit (−) to be close to each other while crossing the high voltage unit (+) and a low voltage unit (−) each other, and supplying power to sufficiently obtain low-hardness water in spite of configuring the water treatment device in a small size and installing the water treatment device on a pipe in which water flows.

### Description of the Related Art

A water treatment device is installed in a pipe that supplies water, cold, hot water, etc. to various buildings that require water such as factories, apartments, swimming pools, and baths, and used to prevent corrosion and red water of the pipe, and to prevent generation and accumulation of bacteria or scale within the pipe.

In order to prevent and remove such scale, a method of applying an electric field onto the pipe, that is, a method of using an electrostatic field is used.

The general water treatment device using the electrostatic field serves as a dielectric with surfaces of a positive electrode (+) and a negative electrode (−).

For example, when a positive electrode (+) and a negative electrode (−) of direct current or pulse type direct current is applied to a cylindrical pipe or a flat pipe, the electrostatic field is generated between an electrostatic system is produced between the positive electrode (+) and the negative electrode (−).

If water exists between the positive electrode (+) and the negative electrode (−), an electric field is charged across the water.

In order to treat a large area and a large capacity, a flat water treatment device having the positive electrode (+) and the negative electrode (−) configured in a flat shape may be provided.

That is, a principle of the electrostatic field water treatment device is to affect particles or bacteria which are present in the water by applying very high DC voltage or pulse voltage (maximum 1000 V or higher) to pipe-structure or flat-structure positive electrode (+) and negative electrode (−).

In this case, the size of the current is very fine (0.01 A or less), and the size of the current does not affect the performance of the device.

A cell membrane of the bacteria in the water is configured by a lipid double membrane and consists of a hydrophilic head and a hydrophobic tail.

A material transmitted into a cell is moved through the protein stuck in the cell membrane, and the configuration of the cell membrane is maintained by the balance of the proper surface tension of the lipid.

When the bacteria are present in the electrostatic field water treatment device having a very large electrostatic field, surface tension characteristics of the bacteria moving in the flow of water are changed by a large electrostatic field, and the balance of the cell membrane is broken.

As a result, a location and a structure of the hydrophilic tail of the lipid are newly transformed, and a sorted part and a destroyed part occur.

In this process, there is a hole in the cell membrane, and external materials such as water ions are injected into the cells, and as a result, the bacteria are expanded and killed.

In addition, the electrostatic field water treatment device having a very large electrostatic field supplies electrons to water flowing between a (+) electrode and a (−) electrode to electrically neutralize cations (CA ++, Mg ++, Fe ++) of scale components, which have repulsive power.

As a result, crystal compounds of the scale attached to the existing discharge pipes can be separated as well as the generation of the scale.

Further, electrons included in the water are abundant, and corrosion can be inhibited due to electron dissolution of metal.

The electrostatic water treatment device is based on a principle of a condenser using the high dielectric constant (=80) of the water.

For example, in the electrostatic water treatment device, a dielectric electrode having the surfaces of the positive electrode (+) and the negative electrode (−) are configured as follows like an electrostatic capacitance condenser.

The electrodes can be divided into electrodes having large and small potentials.

In this case, an electrode having a potential of 0 V is connected to the ground, the ground becomes the (−) electrode, and an electrode having a large potential (approximately +1000 V or −1000 V) becomes the positive electrode (+).

A lot of current flows through the water between the surfaces of the positive electrode (+) and the negative electrode (−).

Therefore, in order to inhibit the current flowing as much as possible, and to configure the electrode such as the principle of the electrostatic capacitance condenser, the positive electrode (+) having the large potential is connected to a conductor such as copper, aluminum, titanium, iron, etc., and the conductor is closed attached and sealed with insulating films such as rubber, ceramic, Teflon, polyethylene, polypropylene, polyurethane, PVC, etc., and is stably insulated up to the durability (5 years or more) according to applied high voltage.

The negative electrode (−) is configured by a conductor, and is connected to a water connection pipe body and the ground simultaneously.

To be descried additionally, in the electrostatic water treatment device, an electrode rod is installed inside the cylindrical pipe in which the water flows.

The negative electrode is applied to the cylindrical pipe, and the positive electrode is applied to an internal electrode rod disposed inside the cylindrical pipe. Here, a key is how stably the internal electrode rod can be insulated.

In the electrostatic water treatment device in the related art, an insulating film is used for insulating the internal electrode rod.

In this case, there is a difficulty in assembly work, and even if a pinhole is generated in the insulating film, there may be a problem in that an insulation destruction occurs.

Therefore, to protect the insulating film of the internal electrode rod, it must be very careful.

For the internal electrode rod, Teflon may be used as the insulating film.

However, Teflon's workability is very difficult, and Teflon is expensive.

The electrostatic water treatment device using Teflon, in the high voltage, has a very short durability, and the replacement time of the electrode is short. Therefore, when Teflon is used, management cost may increase.

For insulating the internal electrode rod, ceramic can be used as the insulating film. The workability of ceramic is very difficult, and ceramic is expensive. Ceramics has an advantage in that the durability is very long, but have a disadvantage that ceramic is easy to break and difficult to handle.

In addition, in the electrostatic water treatment device in the related art, since an inlet direction of the water and an outlet direction of the water form a right angle, the electrostatic water treatment device is resisted to the flow of the water.

Further, the electrostatic water treatment device in the related art is difficult to install in the existing installed pipe facility.

Considering this point, an electrostatic water treatment device has been proposed in Patent Application No. 10-2015-0143110, which has been matured into Korean patent No. 10-1746174 on Jun. 5, 2017.

When the electrostatic water treatment device is described, the general electrostatic water treatment device in the related art includes a water inlet fixation body connected to a pipe into which water is injected, a turbo generator fixed to the water inlet fixation body and generating electricity, an electrostatic water treatment unit removing bacteria or scales included in the water injected through the pipe, a fixation unit connected to the electrostatic water treatment unit and fixed to the turbo generator, a high-voltage converter changing a voltage generated by the turbo generator to a high voltage, a filter filtering water passing through the electrostatic water treatment unit, a water outlet fixation body connected to a pipe through which the water is discharged, and a body covering the turbo generator, the electrostatic water treatment unit, the fixation unit, the high-voltage converter, and the filter disposed between the water inlet fixation body and the water outlet fixation body, and the electrostatic water treatment unit includes a high-voltage unit to which the high voltage is supplied and a ground unit connected to the ground and used as a pipe through which the water passes, the high-voltage unit is disposed at a center portion of the ground unit, and the high voltage unit includes a high-voltage insulation cable to which the high voltage is supplied, and an electrode case covering the high-voltage insulation cable, and configured by a non-conductor, the pipe is formed by any one of conductor iron, aluminum, copper, and titanium, the high voltage is DC voltage or pulse voltage, the high voltage has a value between +1000 V to −1000 V, the non-conductor is formed by any one of glass, polyethylene, polypropylene, PVC, and Teflon, the size of current is 0.01 A or less, and an input direction and an output direction of the water of the ground unit are provided at one end or both ends of the ground unit.

However, the general electrostatic water treatment device in the related art configure as such has a disadvantage in that a gap between the high-voltage unit and the ground unit is too large, efficiency is low in water treatment.

### SUMMARY OF THE INVENTION

Therefore, the present invention is contrived to solve the problems, and the present invention has been made in an effort to provide a water treatment device using an electrostatic field, which configures a water treatment device to generate a large amount of static electricity between a high voltage unit (+) and a low voltage unit (−) by installing the high voltage unit (+) and the low voltage unit (−) to be close to each other while crossing the high voltage unit (+) and a low voltage unit (−) each other, and supplying power to sufficiently obtain low-hardness water in spite of configuring the water treatment device in a small size and installing the water treatment device on a pipe in which water flows.

Other objects of the present invention will be apparent as the description proceeds.

In order to achieve the object, an exemplary embodiment of the present invention provides a water treatment device 100 using an electrostatic field which includes: a housing 110 installed on a pipe in which water flows and provided as a conductor so that water flows in and flows out; a ground unit 120 manufactured by the conductor, and having multiple ground-unit ground plates 122 in which one end is fixed onto a bottom surface of the housing 110 and the other ends are spaced apart from each other at a predetermined interval which protrude upwards and contact water; a high-voltage unit installation member 140 formed in a plate shape to be seated on a top surface of the housing 110 and fixed with multiple fixation screws with an airtight maintaining ring 130 interposed therebetween, and having multiple high-voltage unit accommodation holes 141 having a slot shape formed on a top surface thereof, and having multiple high-voltage unit accommodation pieces 142 including the high-voltage unit accommodation hole 141 and protruding downwards and having accommodation grooves formed therein and spaced apart from each other and formed at a predetermined interval so that a ground unit ground plate 122 of the ground unit 120 into a space between the high-voltage unit accommodation pieces 142 on a bottom surface, and provided with epoxy filled up to the accommodation groove of the high-voltage unit accommodation piece 142 for insulation on the top surface; a high-voltage unit 150 in which one end is inserted into the high-voltage unit accommodation piece 142 of the high-voltage unit installation member 140 and the other ends are protruded and connected to each other through a connection access bar 151; a high-voltage converter 160 of which a part is installed on the top surface of the high-voltage unit installation member 140 to be buried in the epoxy, and converting a voltage supplied from the outside into a high voltage to connect a positive electrode to the connection access bar 151 connecting the high-voltage units 151 to each other and connect a negative electrode to any one of multiple screws 161 fixed to the housing 110; and a cover unit 170 having a fixation screw hole on a top surface to be fixed with a screw by converting an upper portion of the high-voltage unit installation member 140, and having a power supply jack 171 on an outer peripheral surface so as to supply power to the high-voltage converter 160.

Further, in the housing 110, an inlet port 111 and an outlet port 112 for inflow and outflow of water are formed on one surface and the other surface, a top surface is opened, an accommodation space unit 113 is formed to accommodate the ground unit 120 and the high-voltage unit accommodation piece 142 of the high-voltage unit installation member 140, a screw groove 114 is formed on the top surface at a predetermined interval in a radial direction so as to fix the high-voltage unit installation member 140 to multiple fixation screws 161, and a fixation protrusion unit 115 with a fixation screw groove is formed to protrude on a bottom surface so as to fix one end of the ground unit 120 with multiple fixation screws.

As described above, according to the water treatment device using an electrostatic field according to the present invention, there is an effect in that a water treatment device is configured to generate a large amount of static electricity between a high voltage unit (+) and a low voltage unit (−) by installing the high voltage unit (+) and the low voltage unit (−) to be close to each other while crossing the high voltage unit (+) and a low voltage unit (−) each other, and supplying power to sufficiently obtain low-hardness water in spite of configuring the water treatment device in a small size and installing the water treatment device on a pipe in which water flows.

### BRIEF DESCRIPTION OF THE DRAWINGS

FIG. 1 is a perspective view illustrating a water treatment device using an electrostatic field according to the present invention.

FIG. 2 is an exploded perspective view illustrating the water treatment device using an electrostatic field according to the present invention.

FIG. 3 is an exploded perspective view of a part of the water treatment device using an electrostatic field according to the present invention.

FIG. 4 is a transverse sectional perspective view illustrating the water treatment device using an electrostatic field according to the present invention.

FIG. 5 is a longitudinal sectional perspective view illustrating the water treatment device using an electrostatic field according to the present invention.

### DETAILED DESCRIPTION OF THE PREFERRED EMBODIMENT

Hereinafter, an exemplary embodiment of a water treatment device using an electrostatic field according to the present invention will be described in detail.

First, among drawings, it should be noted that same constituent elements or components are represented by the same reference numerals. In describing the present invention, a detailed description of known functions and configurations incorporated will be omitted so as to avoid obscuring the gist of the present invention.

As illustrated, a water treatment device using an electrostatic field according to the present invention is configured to sufficiently obtain low-hardness water in spite of configuring the water treatment device in a small size and installing the water treatment device on a pipe in which water flows.

That is, the water treatment device 100 using an electrostatic field according to the present invention is configured to include: a housing 110 installed on a pipe in which water flows and provided as a conductor so that water flows in and flows out; a ground unit 120 manufactured by the conductor, and having multiple ground-unit ground plates 122 in which one end is fixed onto a bottom surface of the housing 110 and the other ends are spaced apart from each other at a predetermined interval which protrude upwards and contact water; a high-voltage unit installation member 140 formed in a plate shape to be seated on a top surface of the housing 110 and fixed with multiple fixation screws with an maintaining airtight ring 130 interposed therebetween, and having multiple high-voltage unit accommodation holes 141 having a slot shape formed on a top surface thereof, and having multiple high-voltage unit accommodation pieces 142 including the high-voltage unit accommodation hole 141 and protruding downwards and having accommodation grooves formed therein and spaced apart from each other and formed at a predetermined interval so that a ground unit ground plate 122 of the ground unit 120 into a space between the high-voltage unit accommodation pieces 142 on a bottom surface, and provided with epoxy filled up to the accommodation groove of the high-voltage unit accommodation piece 142 for insulation on the top surface; a high-voltage unit 150 in which one end is inserted into the high-voltage unit accommodation piece 142 of the high-voltage unit installation member 140 and the other ends are protruded and connected to each other through a connection access bar 151; a high-voltage converter 160 of which a part is installed on the top surface of the high-voltage unit installation member 140 to be buried in the epoxy, and converting a voltage supplied from the outside into a high voltage to connect a positive electrode to the connection access bar 151 connecting the high-voltage units 151 to each other and connect a negative electrode to any one of multiple screws 161 fixed to the housing 110; and a cover unit 170 having a fixation screw hole on a top surface to be fixed with a screw by converting an upper portion of the high-voltage unit installation member 140, and having a power supply jack 171 on an outer peripheral surface so as to supply power to the high-voltage converter 160.

Further, the cover unit 170 further includes a notification lamp 180 which is connected to the power supply jack 171 via a power supply line to notify whether the water treatment device is actuated to a user.

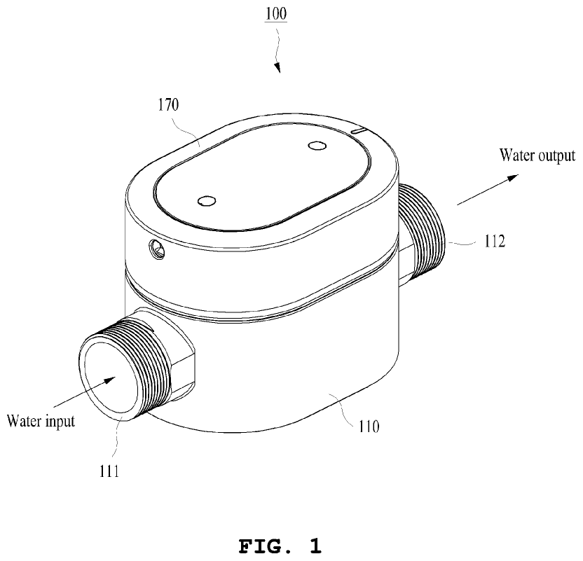

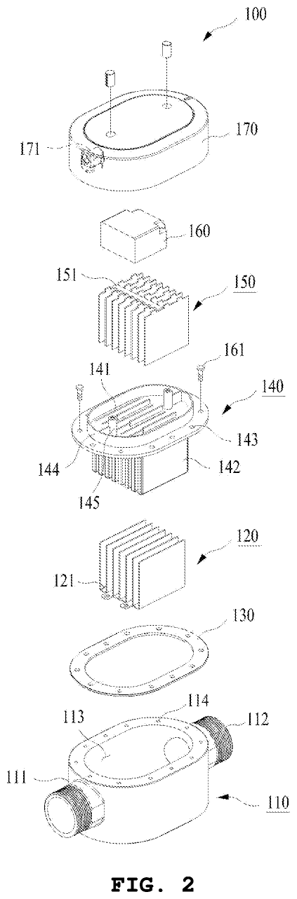

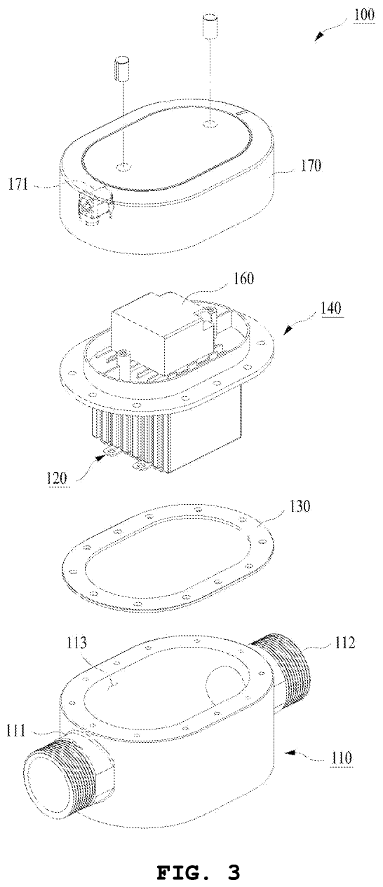

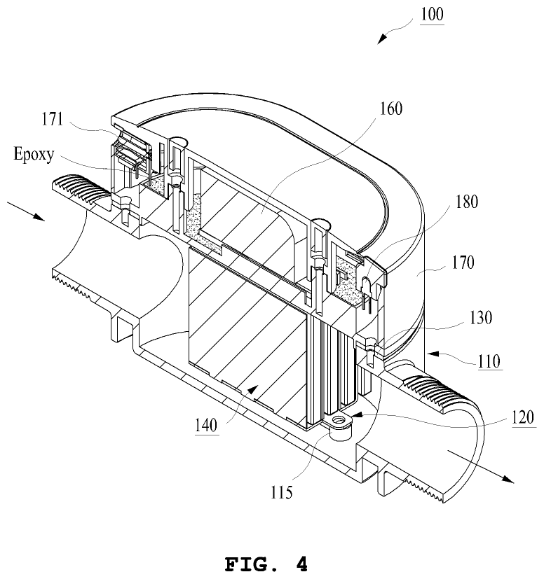

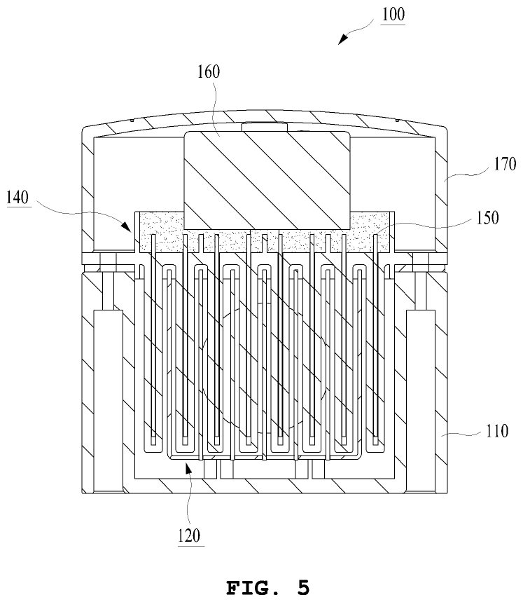

Hereinafter, the water treatment device using an electrostatic field according to the present invention will be described in more detail as follows with reference to FIGS. 1 to 5 which are the accompanying drawings.

First, the housing 110 of the water treatment device using an electrostatic field according to the present invention is provided as a conductor which is installed on a pipe in which water flows to enable the water to flow in and flow out.

That is, in the housing 110, an inlet port 111 and an outlet port 112 for inflow and outflow of water are formed on one surface and the other surface, a top surface is opened, and an accommodation space unit 113 is formed to accommodate the ground unit 120 and the high-voltage unit accommodation piece 142 of the high-voltage unit installation member 140.

Further, a screw groove 114 is formed on the top surface of the housing 110 at a predetermined interval in a radial direction so as to fix the high-voltage unit installation member 140 to multiple fixation screws 161.

In addition, a fixation protrusion unit 115 with a fixation screw groove is formed to protrude on a bottom surface of the housing 114 so as to fix one end of the ground unit 120 with multiple fixation screws.

The ground unit 120 is manufactured by the conductor, and has multiple ground-unit ground plates 122 in which one end is fixed onto a bottom surface of the housing 110 and the other ends are spaced apart from each other at a predetermined interval to be inserted between the high-voltage unit accommodation pieces 142 of the high-voltage unit installation member 140 accommodated by the accommodation space unit 113 of the housing 110, which protrude upwards and contact water.

That is, the ground unit 120 is constituted by a plate-shaped ground unit plate 121 having multiple fixation pieces 121a having fixations formed at both ends, respectively so as to be fixed to the fixation protrusion unit which protrudes on the bottom surface of the housing 110 with multiple fixation screws, and multiple ground unit ground plates 122 which protrude on a top surface of the ground unit plate at a predetermined interval and inserted between the high-voltage unit accommodation pieces 142 of the high-voltage unit installation member 140 accommodated by the accommodation space unit 113 of the housing 110.

The high-voltage unit installation member 140 is formed in a plate shape to be seated on a top surface of the housing 110 and fixed with multiple fixation screws 161 with an airtight maintaining ring 130 interposed therebetween so as to insert each of the high-voltage units 150, and having multiple high-voltage unit accommodation holes 141 having a slot shape formed on a top surface thereof, and having multiple high-voltage unit accommodation pieces 142 including the high-voltage unit accommodation hole 141 and protruding downwards and having accommodation grooves formed therein and spaced apart from each other and formed at a predetermined interval so that a ground unit ground plate 122 of the ground unit 120 into a space between the high-voltage unit accommodation pieces 142 on a bottom surface so as to insert each of one end of the high-voltage unit 150, and provided with epoxy filled up to the inside of the high-voltage unit accommodation piece 142 for insulation on the top surface.

Further, multiple installation member fixation holes 143 are formed at a fore-end portion of the top surface of the high-voltage unit installation member 140 at a predetermined interval in the radial direction to be fixed to the housing 110 with multiple fixation screws 161.

In addition, a ring-shaped epoxy filling protrusion piece 144 protrudes upwards from the top surface of the high-voltage unit installation member 140, and is positioned at one side of the installation member fixation hole 143 and formed to fill the epoxy.

In addition, a cover unit fixing fixation unit 145 having a screw groove protrudes from the top surface of the high-voltage unit installation member 140, and is positioned inside the epoxy filling protrusion piece 144 to fix the cover unit 170 with the screw.

In the high-voltage unit 150, one end is inserted into the high-voltage unit accommodation piece 142 of the high-voltage unit installation member 140 and the other ends are protruded and connected to each other through a connection access bar 151.

That is, the high-voltage unit 150 is formed in a plate shape so that one end is inserted into the high-voltage unit accommodation piece 142 of the high-voltage unit installation member 140, and each accommodation groove is formed at an upper end of each plate so as to accommodate one surface of the connection access bar 151 and fix one surface by welding in order to quickly perform an insertion work.

The high-voltage converter 160 is installed on the top surface of the high-voltage unit installation member 140, and converts a voltage supplied from the outside into a high voltage to connect a positive electrode of the high voltage (+1000 V or more or −1000 V or less) to the connection access bar 151 connecting the high-voltage units 150 and connect a negative electrode applied with 0 V to any one of multiple screws 161 fixed to the housing 110.

Here, a part of the high-voltage converter 160 is buried in and fixed to epoxy.

The cover unit 170 is provided to cover an upper portion of the high-voltage unit installation member 140.

That is, the cover unit 170 has a fixation screw hole on both sides of a top surface to be fixed with the cover unit fixing fixation unit 145 and a screw by converting an upper portion of the high-voltage unit installation member 140, and has a power supply jack 171 on an outer peripheral surface so as to supply power to the high-voltage converter 160.

When the water treatment device using an electrostatic field according to the present invention configured as such is installed on the pipe and is applied with the power, static electricity is generated between the ground unit 120 applied with a voltage of 0 V and the high-voltage unit 150 applied with the high voltage of 1000 V.

That is, the static electricity is generated between the ground unit ground plate 122 of the ground unit 120 and the high-voltage unit accommodation piece 142 of the high-voltage unit installation member 140 inserted with each high-voltage unit 150.

Water having low hardness may be obtained by the static electricity while the water which flows in through the inlet port 111 passes between the ground unit 120 and the high-voltage unit accommodation piece 142 of the high-voltage unit installation member 140 inserted with the high-voltage unit 150.

The above description just illustrates the technical spirit of the present invention and various changes and modifications can be made by those skilled in the art to which the present invention pertains without departing from an essential characteristic of the present invention. Accordingly, the exemplary embodiments disclosed herein are intended to not limit but describe the technical spirit of the present invention but the scope of the technical spirit of the present invention is not limited by the exemplary embodiments. The protection scope of the present invention should be construed based on the following appended claims and it should be appreciated that the technical spirit included within the scope equivalent to the claims belongs to the scope of the present invention.

What is claimed is:

1. A water treatment device using an electrostatic field, comprising:
a housing (110) installed on a pipe in which water flows and provided as a conductor so that water flows in and flows out;
a ground unit (120) manufactured by the conductor, and having multiple ground-unit ground plates (122) in which one end is fixed onto a bottom surface of the housing (110) and the other ends are spaced apart from each other at a predetermined interval which protrude upwards and contact water;
a high-voltage unit installation member (140) formed in a plate shape to be seated on a top surface of the housing (110) and fixed with multiple fixation screws with an airtight maintaining ring (130) interposed therebetween, and having multiple high-voltage unit accommodation holes (141) having a slot shape formed on a top surface thereof, and having multiple high-voltage unit accommodation pieces (142) including the high-voltage unit accommodation hole (141) and protruding downwards and having accommodation grooves formed therein and spaced apart from each other and formed at a predetermined interval so that a ground unit ground plate (122) of the ground unit (120) into a space between the high-voltage unit accommodation pieces (142) on a bottom surface, and provided with epoxy filled up to the accommodation groove of the high-voltage unit accommodation piece (142) for insulation on the top surface;
a high-voltage unit (150) in which one end is inserted into the high-voltage unit accommodation piece (142) of the high-voltage unit installation member (140) and the other ends are protruded and connected to each other through a connection access bar (151);
a high-voltage converter (160) of which a part is installed on the top surface of the high-voltage unit installation member (140) to be buried in the epoxy, and converting a voltage supplied from the outside into a high voltage to connect a positive electrode to the connection access bar (151) connecting the high-voltage units (151) to each other and connect a negative electrode to any one of multiple screws (161) fixed to the housing (110); and
a cover unit (170) having a fixation screw hole on a top surface to be fixed with a screw by converting an upper portion of the high-voltage unit installation member (140), and having a power supply jack (171) on an outer peripheral surface so as to supply power to the high-voltage converter (160).

2. The water treatment device of claim 1, wherein in the housing (110), an inlet port (111) and an outlet port (112) for inflow and outflow of water are formed on one surface and the other surface, a top surface is opened, an accommodation space unit (113) is formed to accommodate the ground unit (120) and the high-voltage unit accommodation piece (142) of the high-voltage unit installation member (140), a screw groove (114) is formed on the top surface at a predetermined interval in a radial direction so as to fix the high-voltage unit installation member (140) to multiple fixation screws (161), and a fixation protrusion unit (115) with a fixation screw groove is formed to protrude on a bottom surface so as to fix one end of the ground unit (120) with multiple fixation screws.

3. The water treatment device of claim 1, wherein the ground unit (120) is constituted by a plate-shaped ground unit plate (121) having multiple fixation pieces (121a) having fixations formed at both ends, respectively so as to be fixed to the fixation protrusion unit which protrudes on the bottom surface of the housing (110) with multiple fixation screws, and multiple ground unit ground plates (122) which protrude on a top surface of the ground unit plate at a predetermined interval and inserted between the high-voltage unit accommodation pieces (142) of the high-voltage unit installation member (140) accommodated by the accommodation space unit (113) of the housing (110).

4. The water treatment device of claim 1, wherein multiple installation member fixation holes (143) are formed at a fore-end portion of the top surface of the high-voltage unit installation member (140) at a predetermined interval in the radial direction to be fixed to the housing (110) with multiple fixation screws (161), a ring-shaped epoxy filling protrusion piece (144) protrudes upwards from the top surface of the high-voltage unit installation member (140), and positioned at one side of the installation member fixation hole (143) to fill the epoxy, and top surface of the high-voltage unit protrudes from the installation member (140), and is positioned inside the epoxy filling protrusion piece (144) to fix the cover unit (170).

5. The water treatment device of claim 2, wherein the ground unit (120) is constituted by a plate-shaped ground unit plate (121) having multiple fixation pieces (121a) having fixations formed at both ends, respectively so as to be fixed to the fixation protrusion unit which protrudes on the bottom surface of the housing (110) with multiple fixation screws, and multiple ground unit ground plates (122) which protrude on a top surface of the ground unit plate at a predetermined interval and inserted between the high-voltage unit accommodation pieces (142) of the high-voltage unit installation member (140) accommodated by the accommodation space unit (113) of the housing (110).
